(19) United States
(12) Patent Application Publication
(10) Pub. No.: US 2013/0125443 A1
(43) Pub. Date: May 23, 2013

(54) ANIMAL CONDITIONING DEVICE

(71) Applicant: Michael R. Ware, Alliance, OH (US)

(72) Inventor: Michael R. Ware, Alliance, OH (US)

(21) Appl. No.: 13/680,633

(22) Filed: Nov. 19, 2012

Related U.S. Application Data
(60) Provisional application No. 61/561,373, filed on Nov. 18, 2011.

(51) Int. Cl. A01M 31/06

(52) U.S. Cl. CPC A01M 31/06
USPC 43/2

(57) ABSTRACT

Provided is a conditioning device for animals, the conditioning device having a collapsible frame and a cover surrounding to the frame, the frame and cover being coupleable to a tree stand. The frame and cover can be coupled to the tree stand when a hunter is not occupying the tree stand to condition animals to an occupant of the tree stand. When the hunter is occupying the tree stand, the frame and cover can be removed, folded up and stored thereby providing a lightweight, portable and easy to install/remove conditioning device.

### RELATED APPLICATIONS

This application claims the benefit of U.S. Provisional Application No. 61/561,373 filed Nov. 18, 2011, which is hereby incorporated herein by reference.

### FIELD OF INVENTION

The present disclosure relates generally to a conditioning device, and more particularly to an animal conditioning device coupleable to a tree stand.

### BACKGROUND

Tree stands can be secured to a tree to elevate a hunter and give the hunter a better vantage point. Typically, tree stands are left in place year-round. Leaving the tree stand in place allows animals, such as a deer, to become acclimate to the tree stand. However, when the hunter returns to the tree stands, the animals, which are sensitive to changes in habits, may be scared off by the change in scenery.

To prevent the animals from being scared off by the presence of the hunter, conditioning devices can be placed on the tree stand when not occupied by the hunter. In this way, when the conditioning device is removed from the tree stand and the hunter positions himself on the tree stand, the animals will be acclimated to the presence of a hunter on the tree stand.

### SUMMARY OF INVENTION

The present invention provides a conditioning device for animals, the conditioning device having a collapsible frame and a cover surrounding to the frame, the frame and cover being coupleable to a tree stand. The frame and cover can be coupled to the tree stand when a hunter is not occupying the tree stand to condition animals to an occupant of the tree stand. When the hunter is occupying the tree stand, the frame and cover can be removed, folded up and stored thereby providing a lightweight, portable and easy to install/remove conditioning device.

According to one aspect, the conditioning device includes a collapsible frame having a stop member at a bottom portion thereof, the stop member having an opening for receiving an end of a support member, and a cover surrounding the frame, the cover including an opening at a bottom portion of the cover for receiving the frame and first and second straps at the bottom portion of the cover configured to couple to cover to the tree stand.

In an embodiment, the conditioning device further includes the support member, wherein the support member has a first end configured to be received in the opening in the stop member and a second end configured to be received in an opening formed by a bracket and a front portion of the tree stand.

In another embodiment, the support member includes a stop configured to abut a top portion of the bracket when the second end of the support member is received in the opening formed by the bracket and the front portion of the tree stand and configured to abut the stop on the frame.

In still another embodiment, the conditioning device further includes the bracket configured to be coupled to the tree stand.

In yet another embodiment, the bracket includes a first end, a second end, and a curved portion, and wherein the first and second ends each include at least one opening for receiving a fastener to couple to the respective end to the tree stand.

In a further embodiment, the conditioning device further includes a bushing configured to be disposed in the opening formed by the bracket and the front portion of the tree stand, wherein the bushing has an opening for receiving the second end of the support member.

In another embodiment, one side of each strap includes hook fastener and loop fastener, and wherein each strap is configured to be wrapped around a front portion of the tree stand to couple the hook fastener to the loop fastener to couple the cover to the tree stand.

In still another embodiment, the conditioning device further includes a camera mount connected to one of the cover, frame, support member or bracket.

In yet another embodiment, the collapsible frame has an outline in the shape of a human torso and head.

According to another aspect, a conditioning device configured to be secured to a tree stand is provided, the conditioning device including a collapsible frame, a cover surrounding the frame, the cover including an opening at a bottom portion of the cover for receiving the frame and at least one strap at the bottom portion of the cover configured to couple to cover to the tree stand, a bracket configured to be coupled to the tree stand and form therewith an opening, and a support member having a first end configured to be received in the open end of the cover and a second end configured to be received in the opening formed by the bracket and tree stand.

In an embodiment, the collapsible frame has an outline in the shape of a human torso and head.

In another embodiment, the bracket includes a first end, a second end, and a curved portion, and wherein the first and second ends each include at least one opening for receiving a fastener to couple to the respective end to the tree stand.

In still another embodiment, the conditioning device further includes a bushing configured to be disposed in the opening formed by the bracket and the front portion of the tree stand, wherein the bushing has an opening for receiving the second end of the support member.

In yet another embodiment, the collapsible frame has a stop member at a bottom portion thereof, the stop member having an opening for receiving the first end of the support member.

In a further embodiment, the support member includes a stop configured to abut a top portion of the bracket when the second end of the support member is received in the opening formed by the bracket and the tree stand.

In another embodiment, the cover further includes a sleeve having a closed end and an open end, the sleeve configured to receive the first end of the support member.

In yet another embodiment, the support member includes a stop configured to abut a top portion of the bracket when the second end of the support member is received in the opening formed by the bracket and the tree stand.

In still another embodiment, the support member includes a second stop configured to abut the open end of the sleeve.

The foregoing and other features of the invention are hereinafter described in greater detail with reference to the accompanying drawings.

### BRIEF DESCRIPTION OF THE DRAWINGS

FIG. 1 is a front view of a conditioning device according to the invention coupled to a tree stand;

FIG. 2 is a front view of a cover of the conditioning device;

FIG. 3 is a front view of a frame of the conditioning device;

FIG. 4 is a perspective view of the conditioning device coupled to the tree stand;

FIG. 5 is a front view of a support member of the conditioning device;

FIG. 6 is a perspective view of a bracket of the conditioning device;

FIG. 7 is a partial front view of the conditioning device coupled to the tree stand;

FIG. 8 is another partial front view of the condition device;

FIG. 9 is a front view of another frame of the conditioning device;

FIG. 10 is a front view of another support member of the conditioning device;

FIG. 11 is a front view of a bushing of the conditioning device; and

FIG. 12 is a front view of another cover of the conditioning device.

### DETAILED DESCRIPTION

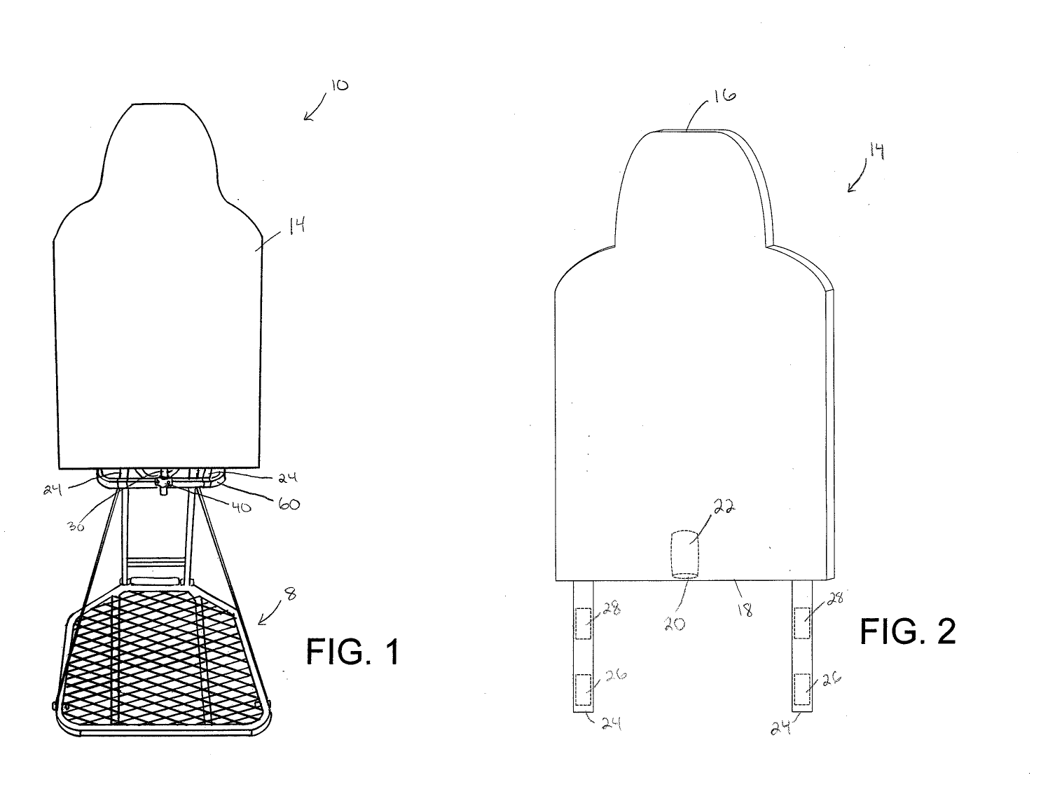

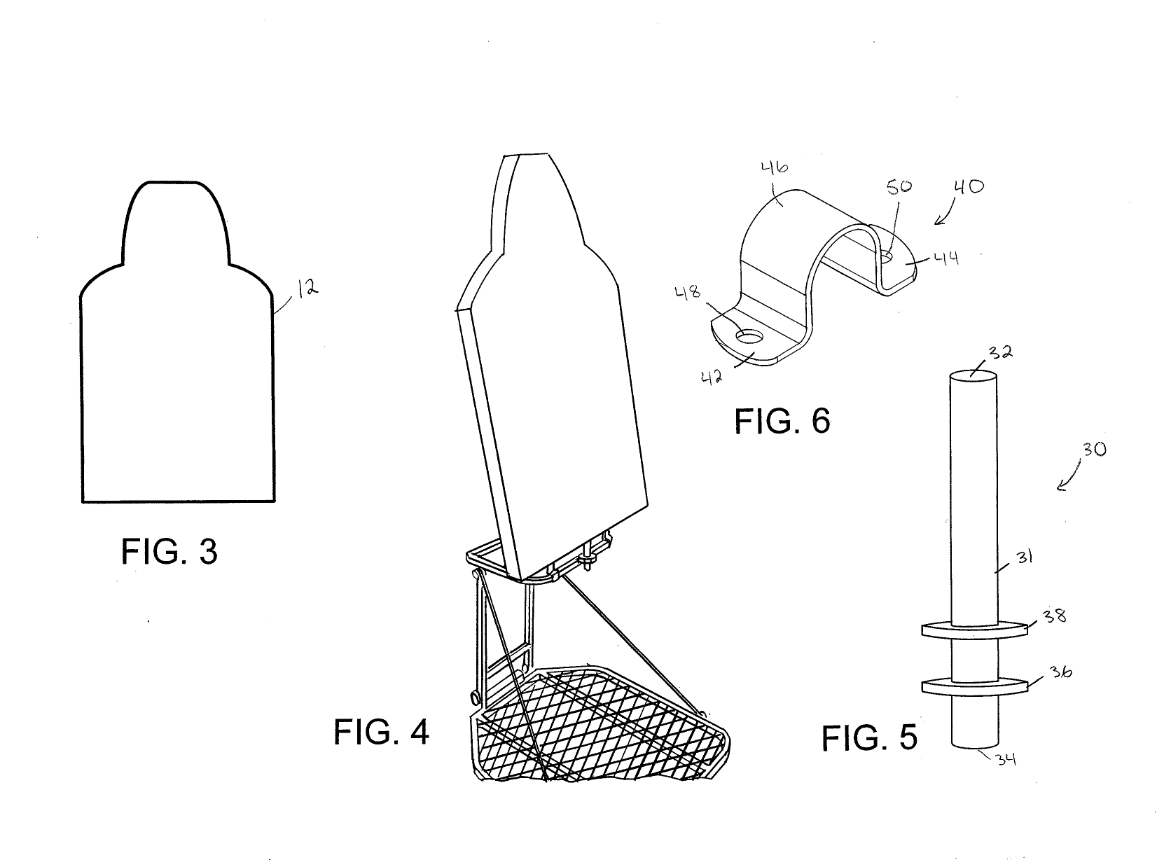

Referring now in detail to the drawings and initially to FIGS. 1-3, an exemplary conditioning device is shown as reference numeral 10. The conditioning device includes a frame 12 and a cover 14 surrounding the frame 12. The frame and cover may have any suitable shape, such as the shape of a torso and head of a human to simulate the presence of a hunter on a tree stand 8. The frame and/or cover may also include or have attached thereto, portions in the shape of arms and or legs.

The frame 12 may be made of any suitable material, such as flex spring steel, and may be collapsible for convenient storage and transportation of the conditioning device. The frame may be formed in one piece, or formed in several pieces secured to one another in any suitable manner, such as by welding. Alternatively, the frame could be formed in several pieces that are removably coupled together to allow the frame to be assembled/disassembled.

The cover 14 may be in the form of a sleeve that is closed at a first end 16 and open at a second end 18. In this way, the cover can be placed around the frame 12 such that the cover 14 surrounds the frame. The cover 14 can then be closed at the second end 18 enclosing the frame 12 within the cover. The second end can be closed by securing ends of the second end together in any suitable manner, such as by sewing, hook and loop fasteners, a zipper, etc. It will be appreciated that either end of the cover may be open/closed or both ends may be open to allow the frame to be inserted into the cover 14, and then the open end(s) closed to enclose the frame 12 within the cover. It will also be appreciated that the cover may be formed as one piece or as multiple pieces. Alternatively, the cover may be formed of a resilient material such as a plastic, thereby eliminating the need for a frame. The cover may be made of any suitable material, such as a suitable fabric having a camouflage pattern thereon. The camouflage pattern may be the same or similar to a camouflage pattern worn by the hunter while using the tree stand. Additionally or alternatively, the fabric may have leaf-like or feather-like portion(s) extending from it that can be blown by wind.

As shown in FIG. 2, the cover 14 has an opening 20, shown in broken lines, formed at the second end 18 of the cover 14 at any suitable location for receiving a support member 30 (FIG. 5). For example, the opening 20 could be formed on a front portion or back portion of the cover 14, such that when the second end 18 is closed, the opening 20 at least partially faces downward. The opening 20 may be an opening of a sleeve or pocket 22 formed in or coupled to the cover to receive an end of the support member 30 that is configured to act as a pivot. Alternatively, the opening 20 may be formed by only partially closing the second end 18 and the support member 30 received therein.

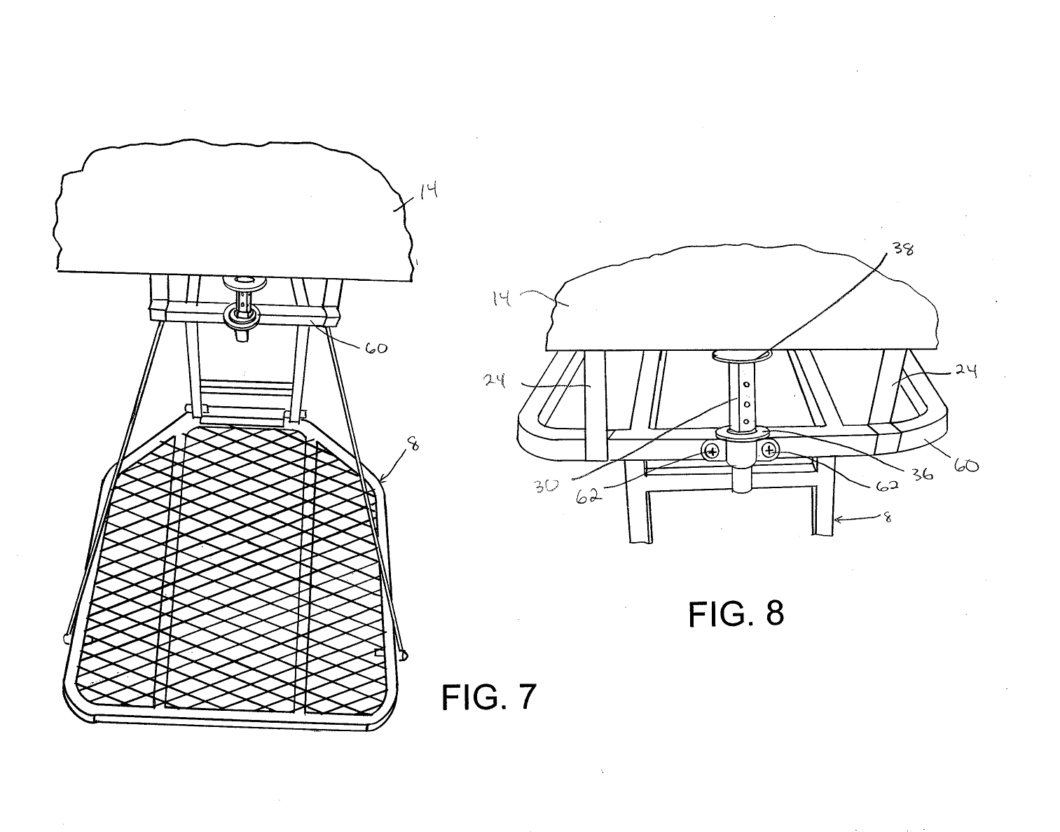

The cover 14 also includes at least one strap 24, and in the illustrated embodiment two straps, provided to secure the conditioning device 10 to the tree stand 8. The straps may be any suitable strap, such as elastic straps, that allow the conditioning device to move with the wind as it blows. The straps 24 may include any suitable fastener, such as hook fastener 26 and loop fastener 28. When the conditioning device is positioned on the tree stand 8, the straps 24 can be wrapped around a bar of the tree stand and the hook fastener 26 coupled to the loop fastener 28. Alternatively, the cover 14 may include at least one strap on the front portion of the cover and at least one strap on the back portion of the cover, where each strap includes a suitable fastener configured to couple to the fastener on the other strap. The straps may be tightened evenly or differently to allow the conditioning device to be angled relative to the tree stand. The straps may have fasteners facing the same direction as shown in FIG. 7 or opposite directions as shown in FIG. 8.

Turning now to FIG. 5 the support member 30 is shown in detail. The support member 30 has a first end 32 configured to be received in the sleeve 22 and a second end 34 configured to be received by a bracket 40 (FIG. 6). The support member includes a body 31, which may have any suitable shape, such as a tubular shape as shown in FIG. 5, a polygonal shape as shown in FIG. 7, etc. The support member also includes at least one stop and in the illustrated embodiment first and second stops 36 and 38. The first and second stops, which may be for example washers, are configured to be coupled to the body 31 in any suitable manner, such as by welding. Alternatively, it will be appreciated that the body 31 and stops 36 and 38 may be integrally formed. Moreover, although shown as being separate from the frame 12, it will be appreciated that the support member 30 may be integrally formed with the frame 12 or coupled to the frame 12.

Turning now to FIG. 6, the bracket 40 is shown in detail. The bracket 40, which may be a u-shaped bracket, includes a first end 42, a second end 44 and a curved portion 46. The first and second ends 42 each include at least one opening 48, 50 for receiving a suitable fastener, such as screws 62 (FIG. 8), to secure the bracket to the tree stand 8. It will be appreciated, however, that the bracket may be coupled to the tree stand in any suitable manner, such as by welding, adhesive, etc. As illustrated in FIG. 1, the bracket 40 is coupled to a front member 60 of the tree stand such that the curved portion 46 forms with the front member 60 an opening for receiving the support member 30. It will be appreciated, however, that the bracket may be coupled to any portion of the tree stand 8 and formed in any suitable manner to receive the support member 30. The bracket may be coupled to the front member 60 and remain in position on the tree stand 8 even when the other elements of the conditioning device are removed, or may be removed when the other elements are removed.

Turning again to the support member 30, the first stop 36 is spaced from the second end 34 of the support member 30 a suitable distance to allow the second end 34 to be received by the bracket 40. The stop 36 is sized to be larger than the opening formed by the bracket 40 and the front member 60 such that the stop is supported by the curved portion 46 and/or the front member 60. The second stop 38 is spaced from the first stop 36 a suitable distance to provide spacing between the cover 14/frame 12 and the front member 60 when the support member 30 is received in the pocket 32. The spacing, along with the elasticity of the straps, allows the cover and frame to move left to right or front to back without interference from the front member 60, for example when the device is blown by the wind, more than it would if the cover and frame abutted the front member. The second stop 38 is sized to be larger than the opening 20 such that the stop 38 supports the second end 18 of the cover 14 and the bottom of the frame 12. It will be appreciated that the stops may be adjustable to allow the spacing to be altered. Additionally or alternatively, a pin may be provided that can be received in openings in the support member, where the pin can act as a stop and allow the spacing to be altered. Alternatively, if the frame is provided with a stop, the stop on the frame can abut the stop 38.

To assemble the conditioning device 10, the frame 12 is inserted into the cover 14 via the opening at the second end 18. The second end is then closed or partially closed, for example by sewing the front portion of the second end 18 to the back portion of the second end 18. To install the conditioning device, the second end 34 of the support member 30 can be inserted into the opening formed by the curved portion 46 of the bracket and the front member 60 so that the stop 30 is supported by the curved portion 46 and front member 60. It will be appreciated that the bracket 40 may be fastened to the front member 60 prior to installation of the rest of the conditioning device. The frame 12 and cover 14 then can be lowered over the support member 30 frame/cover abut the stop 38 of the support member 30 and/or the support member is surrounded by the sleeve 22. The straps 34 then can be wrapped around the front member 60 and the hook fastener 26 coupled to the loop fastener 28. It should be appreciated that the foregoing steps may be performed in any suitable order.

In this way, the frame 12 and cover 14 can be coupled to the tree stand 8 when a hunter is not occupying the tree stand to condition animals, such as deer, to an occupant of the tree stand 8. When the hunter is occupying the tree stand, the straps 24 can be unfastened, the frame 12, cover 14 and support member removed, and then folded up and stored. The conditioning device 10 therefore provides a lightweight, portable and easy to install conditioning device.

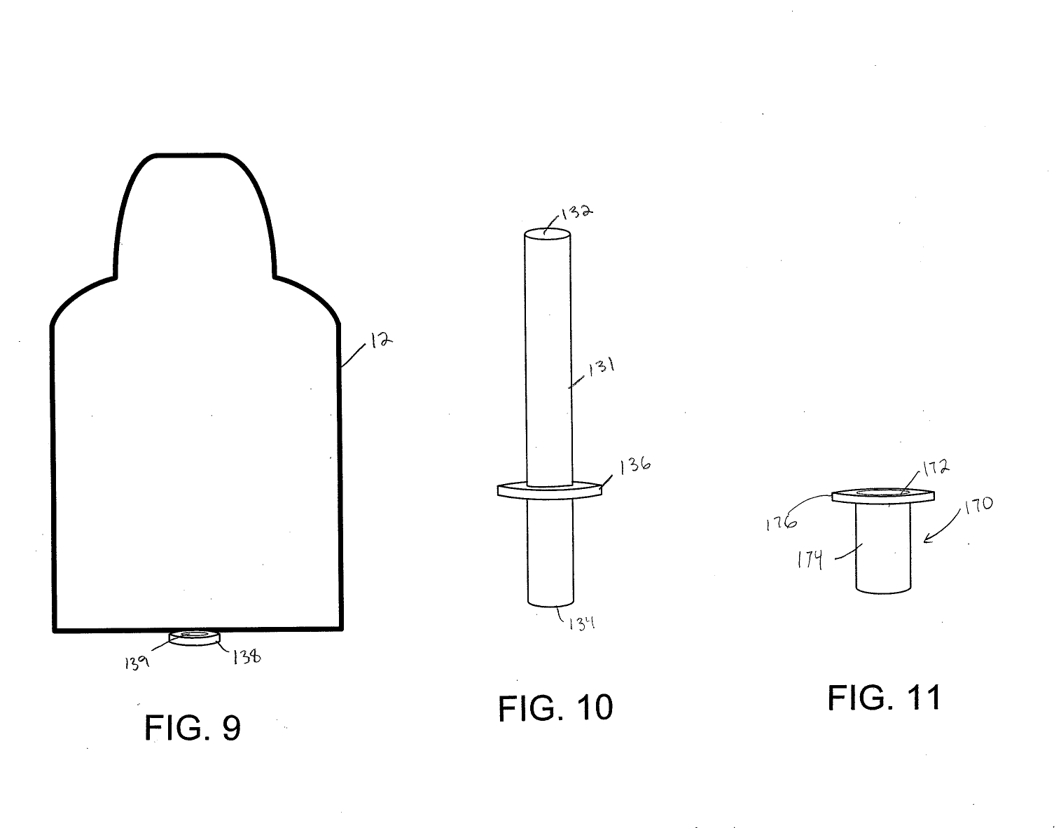

Turning now to FIG. 9-12, an exemplary embodiment of the conditioning device 110 shown. The conditioning device 110 is substantially the same as the above-referenced conditioning device 10, and consequently the same reference numerals but indexed by 100 are used to denote structures corresponding to similar structures in the frame and support member. In addition, the foregoing description of the conditioning device 10 is equally applicable to the conditioning device 10 except as noted below. Moreover, it will be appreciated upon reading and understanding the specification that aspects of the conditioning devices may be substituted for one another or used in conjunction with one another where applicable.

Turning now to FIG. 9, the frame 112 has a stop 138 at a bottom portion thereof. The stop, which may be for example a washer, may be integrally formed with the frame or coupled to the frame in any suitable manner, for example by welding. The stop may be inside the cover 114 or outside the cover 114 when the second end 118 is closed. The stop includes an opening 139 for receiving a first end 132 of the support member 130. The stop 138 may be used instead of a second stop on the support member 130, or the stop 138 may be used in addition to a second stop on the support member. For example, if the support member does not include a second stop, the support member is received in the opening 139 and slides through the opening until the stop 138 abuts the stop 136 or other suitable stop on the support member. If the support member includes a second stop, such as the stop 38 shown in FIG. 5, then the stop 138 would abut the second stop when the support member is received in the opening 139.

Turning now to FIG. 10, the support member 130 is shown in detail. The support member 130 has a first end 132 configured to be received in the stop 138 and a second end 134 configured to be received by the bracket 40 or a bushing 170 (FIG. 11). The support member also includes at least one stop 136, which may be for example a washer, configured to be coupled to the body 131 in any suitable manner, such as by welding. Alternatively, it will be appreciated that the body 131 and stop 136 may be integrally formed. Moreover, although shown as being separate from the frame 112, it will be appreciated that the support member 130 may be integrally formed with the frame 112 or coupled to the frame 112.

Turning now to FIG. 11, a bushing 170 may be disposed in the opening formed by the bracket 40 and the front portion 60 of the tree stand. The bushing has an opening 172 extending all the way through a body 174 of the bushing or only partially through the body of the bushing for receiving the second end of the support member. The bushing 170 also includes a flange portion 176 that acts as a stop to hold the bushing in position in the opening formed by the bracket and tree stand. It will be appreciated that if the bushing has a closed end opposite the end with the flange, the support member may be provided without the stop 136, as the closed end serves as a stop for the second end 134 of the support member and the flange serves as a stop for the stop 138.

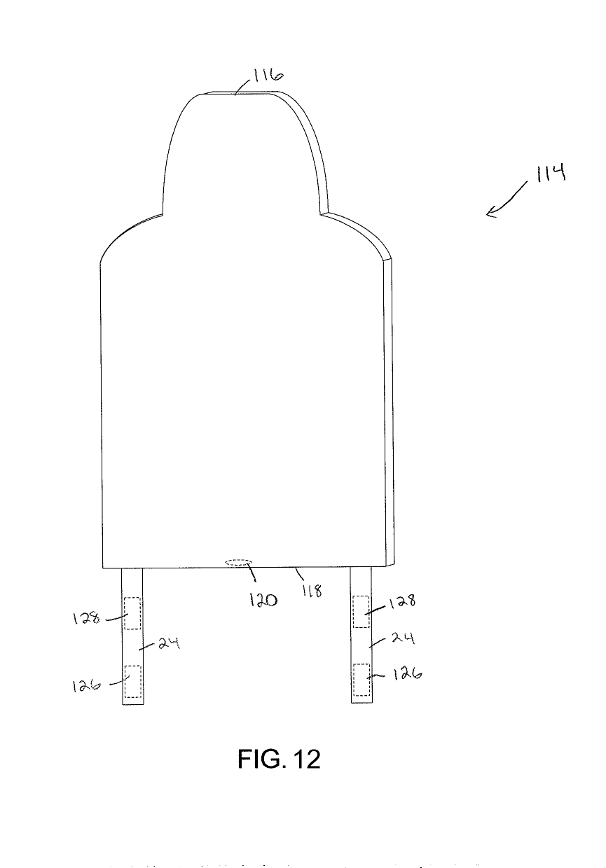

Turning now to FIG. 12, the cover 114 has an opening 120, shown in broken lines, formed at the second end 118 of the cover 114 at any suitable location for receiving a support member 130. The opening may be formed by only partially closing the second end 118 of the cover 114 or may be preformed in the cover.

To install the conditioning device, the second end 134 of the support member 130 can be inserted into the bushing 170 until the stop 136 abuts the flange portion 176 (the bushing is disposed in the opening formed by the curved portion 46 of the bracket and the front member 60 so that the flange 176 of the bushing is supported by the curved portion 46 and front member 60). The frame 112 and cover 114 then can be lowered over the support member 130 until the first end 132 of the support member 130 is received in the opening 139 and the stop 138 abuts the stop 136. The straps 134 then can be wrapped around the front member 60 and the hook fastener 126 coupled to the loop fastener 128. It should be appreciated that the foregoing steps may be performed in any suitable order.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A conditioning device configured to be secured to a tree stand, the conditioning device including:
a collapsible frame having a stop member at a bottom portion thereof, the stop member having an opening for receiving an end of a support member; and
a cover surrounding the frame, the cover including an opening at a bottom portion of the cover for receiving the frame and first and second straps at the bottom portion of the cover configured to couple to cover to the tree stand.

2. The conditioning device of claim 1, further including the support member, wherein the support member has a first end configured to be received in the opening in the stop member and a second end configured to be received in an opening formed by a bracket and a front portion of the tree stand.

3. The conditioning device of claim 2, wherein the support member includes a stop configured to abut a top portion of the bracket when the second end of the support member is received in the opening formed by the bracket and the front portion of the tree stand and configured to abut the stop on the frame.

4. The conditioning device of claim 3, further including the bracket configured to be coupled to the tree stand.

5. The conditioning device of claim 4, wherein the bracket includes a first end, a second end, and a curved portion, and wherein the first and second ends each include at least one opening for receiving a fastener to couple to the respective end to the tree stand.

6. The conditioning device of claim 5, further including a bushing configured to be disposed in the opening formed by the bracket and the front portion of the tree stand, wherein the bushing has an opening for receiving the second end of the support member.

7. The conditioning device of claim 1, wherein one side of each strap includes hook fastener and loop fastener, and wherein each strap is configured to be wrapped around a front portion of the tree stand to couple the hook fastener to the loop fastener to couple the cover to the tree stand.

8. The conditioning device of claim 1, further including a camera mount connected to one of the cover, frame, support member or bracket.

9. The conditioning device of claim 1, wherein the collapsible frame has an outline in the shape of a human torso and head.

10. A conditioning device configured to be secured to a tree stand, the conditioning device including:
a collapsible frame;
a cover surrounding the frame, the cover including an opening at a bottom portion of the cover for receiving the frame and at least one strap at the bottom portion of the cover configured to couple to cover to the tree stand;
a bracket configured to be coupled to the tree stand and form therewith an opening; and
a support member having a first end configured to be received in the open end of the cover and a second end configured to be received in the opening formed by the bracket and tree stand.

11. The conditioning device of claim 10, wherein the collapsible frame has an outline in the shape of a human torso and head.

12. The conditioning device of claim 10, wherein the bracket includes a first end, a second end, and a curved portion, and wherein the first and second ends each include at least one opening for receiving a fastener to couple to the respective end to the tree stand.

13. The conditioning device of claim 12, further including a bushing configured to be disposed in the opening formed by the bracket and the front portion of the tree stand, wherein the bushing has an opening for receiving the second end of the support member.

14. The conditioning device of claim 10, wherein the collapsible frame has a stop member at a bottom portion thereof, the stop member having an opening for receiving the first end of the support member.

15. The conditioning device of claim 14, wherein the support member includes a stop configured to abut a top portion of the bracket when the second end of the support member is received in the opening formed by the bracket and the tree stand.

16. The conditioning device of claim 10, wherein the cover further includes a sleeve having a closed end and an open end, the sleeve configured to receive the first end of the support member.

17. The conditioning device of claim 16, wherein the support member includes a stop configured to abut a top portion of the bracket when the second end of the support member is received in the opening formed by the bracket and the tree stand.

18. The conditioning device of claim 17, wherein the support member includes a second stop configured to abut the open end of the sleeve.

19. A conditioning device according to claim 10 in combination with the tree stand, wherein the bracket is coupled to the tree stand by at least one fastener.
